(19) United States
(12) Patent Application Publication
(10) Pub. No.: US 2011/0219784 A1
(43) Pub. Date: Sep. 15, 2011

(54) COMPRESSOR SECTION WITH TIE SHAFT COUPLING AND CANTILEVER MOUNTED VANES

(76) Inventors: Christopher St. Mary, Hebron, CT (US); Roland R. Barnes, Bloomfield, CT (US); Carl S. Richardson, South Berwick, ME (US); Daniel Benjamin, Simsbury, CT (US)

(21) Appl. No.: 12/720,749

(22) Filed: Mar. 10, 2010

(51) Int. Cl. F02C 3/04; F04D 29/56

(52) U.S. Cl. 60/805; 415/151

(57) ABSTRACT

A compressor section to be mounted in a gas turbine engine has a plurality of compressor rotors arranged from an upstream location toward a downstream location. A tie shaft applies an axial force at one end of the compressor section to a downstream one of the compressor rotors, and biases the compressor rotors against a hub at the opposite end. Vane sections are mounted intermediate the compressor rotors. The vane sections include at least some variable vanes driven by actuators mounted at a radially outer position and at least some of the fixed vanes are cantilever mounted , such that they are spaced from a compressor rotor, but unsecured at a radially inner end.

### BACKGROUND OF THE INVENTION

This application relates to a gas turbine engine with an axial high pressure compressor, wherein a tie shaft holds the high pressure compressor section together.

Gas turbine engines are known, and typically include a compressor, which compresses air and delivers it downstream into a combustion section. The air is mixed with fuel in the combustion section and combusted. Products of this combustion pass downstream over turbine rotors, driving the turbine rotors to rotate.

Typically, the compressor section is provided with a plurality of rotor serial stages, or rotor sections. Traditionally, these stages were bolted together and included bolt flanges, or other structure to receive the attachment bolts. Other applications have rotors welded together.

More recently, it has been proposed to eliminate all of the bolts or weld joints and the flanges with a single coupling which applies a force through the compressor rotors using a tie shaft that clamps the rotors together and provides the friction necessary to transmit torque.

Typically, the compressor rotor stages alternate with stationary vanes. These non-rotating airfoils can be either variable or fixed. Variable vanes are known having an actuator which changes an angle of incidence of the vane relative to the air approaching the vane, and being delivered to the next downstream compressor rotor stage. These vanes are pivot mounted, have typically had their actuator at an outer periphery and feature abradable material that seals against the knife edges mounted on the mating compressor rotor.

Cantilever mounted vanes are a variety of fixed vanes used mostly for radially short airfoils that do not require a shrouded support at their inner end—they have not been utilized in compressor sections with a tie shaft coupling.

### SUMMARY OF THE INVENTION

A compressor section to be mounted in a gas turbine engine has a plurality of compressor rotors arranged from an upstream location toward a downstream location. The compressor rotors stack is bounded by one hub at the upstream end and another hub at the downstream end. Vane sections are mounted intermediate the compressor rotors. The vane sections include pivot mounted variable vanes driven by actuators mounted at a radially outer position and fixed vanes. At least some of the fixed vanes are cantilever mounted, such that they are spaced from a compressor rotor, but unsecured at a radially inner end.

A gas turbine engine incorporating such structure is also claimed.

These and other features of the present invention can be best understood from the following specification and drawings, the following of which is a brief description.

### BRIEF DESCRIPTION OF THE DRAWINGS

FIG. 1 is a cross-sectional view through a gas turbine engine incorporating this invention.

### DETAILED DESCRIPTION OF THE PREFERRED EMBODIMENT

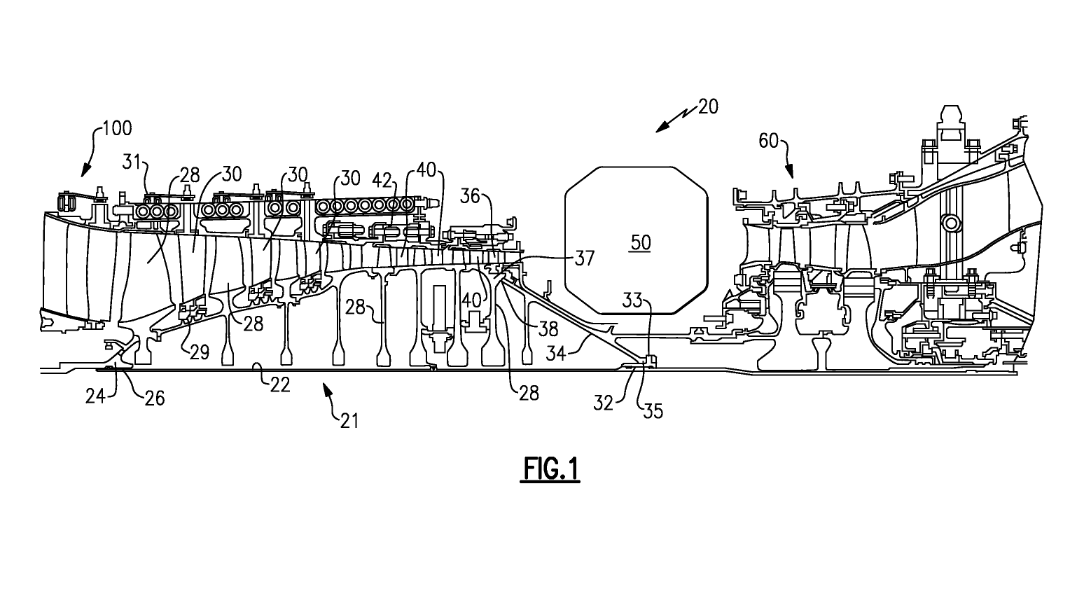

A portion of gas turbine engine 20 is illustrated in FIG. 1. A high pressure rotor section 21 includes an upstream hub 24 which is threadably connected at 26 to the tie shaft 22 for the gas turbine engine. Notably, a low pressure compressor 100 can be positioned upstream of the high pressure compressor section 21. A plurality of compressor stages or rotors 28 are aligned axially from left to right in this view, and compress air and pass it downstream toward the combustion chamber 50. Spaced between the compressor stages 28 are a plurality of vanes 30 and 40. The vanes 30 are variable position vanes, and include actuator 31 at an outer periphery, and pivot mounts 29 at an inner periphery.

As can be appreciated, while a single blade and a single vane are shown at each axial location in FIG. 1, in fact, both structures surround a circumference of a central axis for the tie shaft 22, and include a plurality of circumferentially spaced airfoils.

Fixed position vanes 40 are cantilever mounted, or unsecured and unconstrained at their inner periphery. The use of the cantilever vanes eliminates pivot mount structure. In combination with the use of the tie shaft, the cantilever mount vanes eliminate a good deal of structure, allowing the envelope of this high pressure compressor to be made much smaller in both axial and radial dimensions. Also, the assembly is simpler and lighter.

The compressor rotors 30 are clamped together between the upstream and downstream hubs, 24 and 34 respectively using the tie shaft 22 to apply the axial force. The axial force is applied to the downstream hub 34 by nut 32 that is threadably secured to the tie shaft 22; the force is transmitted from nut 32 to the downstream hub 34 through an end 35 abutting a ledge 33 on a nut 32. The upstream hub 34 applies a force at contact face 38 of the most downstream compressor stage 37. This stage 37 includes airfoils 36 positioned to be radially outwardly of contact face 38 of the tie shaft 34. The nut 32 is threadably secured to the tie shaft 22. In this manner, force is loaded to the downstream hub 34 and onto the most downstream compressor rotor section 37, which in turn applies the force to hold all of the other compressor rotor sections against the upstream hub 24 and creates the friction necessary to transmit torque.

As is known, air compressed by the compressor section 21 is delivered downstream into a combustion section 50 (shown schematically) and from the combustion section 50 into a turbine section 60. The turbine section 60 may also be secured using a tie shaft coupling, as is partially shown here.

The use of the tie shaft mount eliminates much of the structure as mentioned above, and further, the combination of this feature with the cantilever mount vanes, allows the more downstream sections of the compressor section to be made much smaller resulting in a smaller radial and axial envelope for the compressor section and a simplified mounting arrangement.

In addition, as can be appreciated, the contact face 38 is radially inward of the airfoils 36. The use of an axial compressor as the most downstream compressor thus provides a smaller radial envelope for the securement structure, again resulting in a smaller overall envelope.

All vanes feature a sealing arrangement against mating features incorporated into the compressor rotors.

Co-pending application serial number______, entitled “Gas Turbine Engine With Tie Shaft for High Pressure Compressor,” filed on even date herewith, focuses on the use of the tie shaft with axial compressor sections. The co-pending patent application serial number______, entitled “Single Tie Rod Connection for Securing Compressor Section and Turbine Section,” filed on even date herewith, focuses on the assembly of turbine and compressor sections. In addition, co-pending application serial number______, entitled “Gas Turbine Engine Rotor Sections Held Together by Tie Shaft, and With Blade Rim Undercut,” filed on even date herewith, focuses on structure to an integrally bladed rotor.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A compressor section to be mounted in a gas turbine engine comprising:
a plurality of compressor rotors arranged from an upstream location toward a downstream location;
upstream and downstream hubs that bound the compressor rotor stack;
a tie shaft to apply a force at a downstream end of said compressor section to a downstream one of said compressor rotors; and
vane sections being mounted intermediate said compressor rotors, said vane sections including at least some variable vanes driven by actuators mounted at a radially outer position, and at least some of said fixed vanes being cantilever mounted from an outer housing, such that they are spaced from a compressor rotor, but unsecured at a radially inner end.

2. The compressor section as set forth in claim 1, wherein said plurality of cantilever mounted fixed vanes are at a downstream location.

3. The compressor section as set forth in claim 2, wherein said downstream one of said compressor rotors is an axial compressor.

4. The compressor section as set forth in claim 1, wherein said downstream one of said compressor rotors is an axial compressor.

5. A gas turbine engine comprising:
a compressor section;
a combustion section downstream of said compressor section;
a turbine section downstream of said combustion section, said turbine section including turbine rotors to drive and rotate rotors associated with said compressor section; and
said compressor section including a plurality of compressor rotors arranged from an upstream location toward a downstream location, a tie shaft to apply a force at a downstream end of said compressor section to a downstream one of said compressor rotors, to clamp said compressor rotors against an upstream hub and provide the necessary friction to transmit torque, vane sections being mounted intermediate said compressor rotors, said vane sections including at least some variable vanes driven by actuators mounted at a radially outer position, and at least some of said fixed vanes being cantilever mounted from an outer housing, such that they are spaced from a compressor rotor, but unsecured at a radially inner end.

6. The gas turbine engine as set forth in claim 5, wherein said plurality of cantilever mounted fixed vanes are at a downstream location.

7. The gas turbine engine as set forth in claim 6, wherein said downstream one of said compressor rotors is an axial compressor.

8. The gas turbine engine as set forth in claim 5, wherein said downstream one of said compressor rotors is an axial compressor.
